(19) United States
(12) Patent Application Publication
(10) Pub. No.: US 2020/0082351 A1
(43) Pub. Date: Mar. 12, 2020

(54) ELECTRONIC DEVICE AND SCHEDULE PROCESSING METHOD THEREFOR

(71) Applicant: HON HAI PRECISION INDUSTRY CO., LTD., New Taipei (TW)

(72) Inventors: I-CHUN CHEN, New Taipei (TW); FU-YEN HSIEH, New Taipei (TW)

(21) Appl. No.: 16/558,566

(22) Filed: Sep. 3, 2019

(30) Foreign Application Priority Data
Sep. 6, 2018 (TW) 107131381

(51) Int. Cl. G06Q 10/10; G06F 21/32

(52) U.S. Cl. CPC G06Q 10/1095; G06F 21/32

(57) ABSTRACT

A method for processing a schedule applicable in an electronic device includes determining at least one scheduled task and at least one application in relation to each scheduled task. The appropriate application in relation to the scheduled task is activated when the predetermined execution time corresponding to the scheduled task arrives. The application is controlled to perform at least one predetermined schedule operation, and prompt a user that the scheduled task is completed.

### CROSS-REFERENCE TO RELATED APPLICATIONS

This application claims priority to Taiwanese Patent Application No. 107131381 filed on Sep. 6, 2018, the contents of which are incorporated by reference herein.

### FIELD

The subject matter herein generally relates to an application technology, and particularly to an electronic device and a schedule processing method therefor.

### BACKGROUND

Smart electronic devices, such as smart phones or tablet computers, have applications with a reminder function. These applications can remind users of processing a schedule item in a predetermined time, such as having a meeting, shopping, account transferring etc. However, when receiving the reminder, the users need to manually activate other applications to process the schedule item. Thus a lot of time may be spent when there are a large number of items on the schedules.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device for processing schedules.

FIG. 2 is a schematic view of a schedule management interface of the electronic device.

FIG. 3 is a schematic view of a setting interface of the electronic device.

FIG. 4 is a schematic view of an application interface of the electronic device.

FIG. 5 is a schematic view of a schedule operation editing interface of the electronic device.

FIG. 6 illustrates a flowchart of an embodiment of a schedule processing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

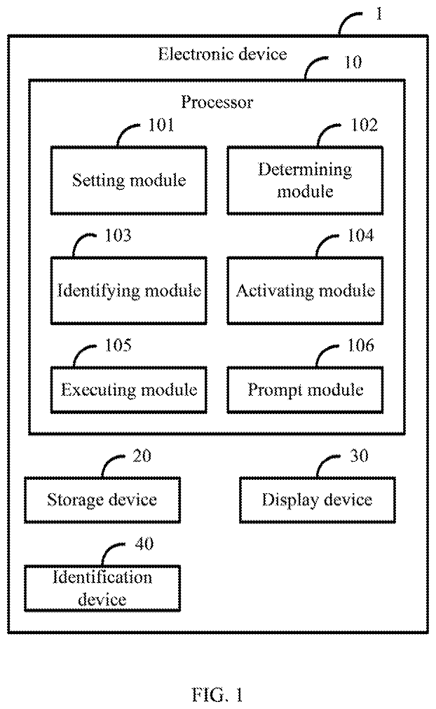

FIG. 1 illustrates an embodiment of an electronic device 1. In at least one embodiment, the electronic device 1 can be a smart phone, a personal computer, and a PDA (Personal Digital Assistant). The electronic device 1 can associate a scheduled task with at least one application, and can control the at least one application to process the scheduled task.

The electronic device 1 includes, but is not limited to, a processor 10, a storage device 20, a display device 30, and an identification device 40. FIG. 1 illustrates only one example of the electronic device 1, other examples can include more or fewer components than illustrated, or have a different configuration of the various components in other embodiments.

The processor 10 can be a central processing unit (CPU), a microprocessor, or other data processor chip that performs functions of the electronic device 1.

In at least one embodiment, the storage device 20 can include various types of non-transitory computer-readable storage mediums. For example, the storage device 20 can be an internal storage system, such as a flash memory, a random access memory (RAM) for temporary storage of information, and/or a read-only memory (ROM) for permanent storage of information. The storage device 20 can also be an external storage system, such as a hard disk, a storage card, or a data storage medium. The storage device 20 stores a number of applications installed in the electronic device 1.

In at least one embodiment, the display device 30 can be a touch screen. The display device 30 displays a user interface of the electronic device 1.

In at least one embodiment, the identification device 40 can be a fingerprint recognition device. The identification device 40 at least includes a fingerprint sensor, the identification device 40 can acquire and identify at least one user fingerprint. In other embodiments, the identification device 40 can also be a face recognition device. The identification device 40 at least includes a camera, the identification device 40 can capture and identify a face image of the user.

As illustrated in FIG. 1, the electronic device 1 at least includes a setting module 101, a determining module 102, an identifying module 103, an activating module 104, an executing module 105, and a prompt module 106. The modules 101-106 can be collections of software instructions stored in the storage device 20 of the electronic device 1 and executed by the processor 10. The modules 101-106 also can include functionality represented as hardware or integrated circuits, or as software and hardware combinations, such as a special-purpose processor or a general-purpose processor with special-purpose firmware.

The setting module 101 is used to determine at least one scheduled task and at least one application in relation to each scheduled task.

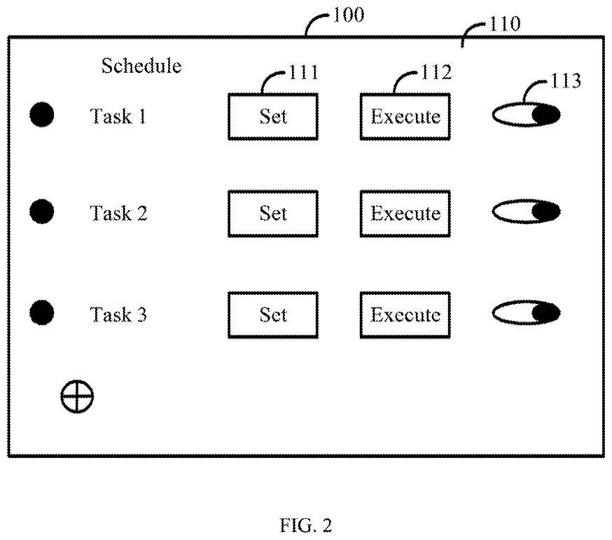

Referring to FIG. 2, in at least one embodiment, a schedule management application 100 is installed in the electronic device 1, the schedule management application 100 manages the at least one scheduled task for the user. When the schedule management application 100 is activated, the electronic device 1 displays a schedule management interface 110 on the display device 30, the user can add, edit, and delete the scheduled task on the schedule management interface 110.

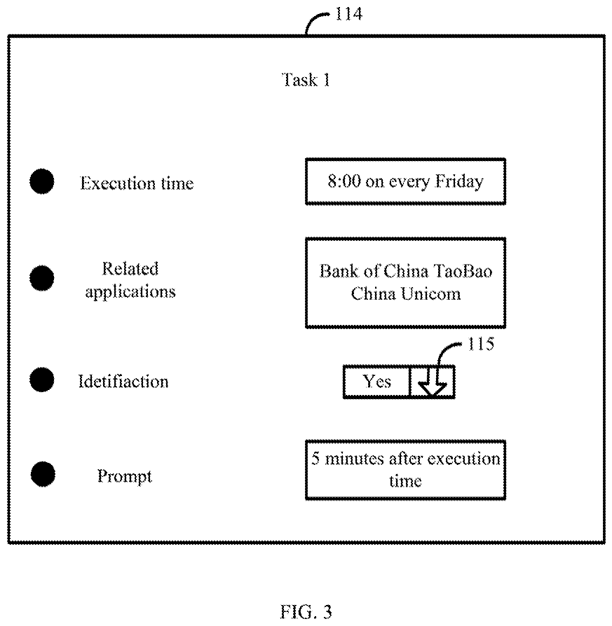

When the user newly adds an task to a schedule or introduces an entire new schedule, the user can preset the new task on the schedule management interface 110. Referring to FIG. 3, when a setting option 111 on the schedule management interface 110 is activated by the user, the schedule management interface 110 provides a setting interface 114, the user can edit the new task on the setting interface 114.

In at least one embodiment, the schedule management interface 110 further defines an executing option 112 and an activating option 113. The executing option 112 is activated by the user to execute the scheduled task. The activating option 113 is a sliding button, the sliding button includes a slider and a sliding area. The activating options 113 can be slid by the user to activate or cancel the scheduled task. In detail, when the slider is slid to a right end of the sliding area, the scheduled task is activated. When the slider is slid to a left end of the sliding area, the scheduled task is canceled.

In at least one embodiment, setting the scheduled task at least includes setting an execution time, setting at least one related application, setting an identification, and setting a prompt.

In detail, setting the execution time includes setting a predetermined time for executing the scheduled task. The execution time can be a certain time within every week, every month, or a special date, such as 9:00 every Friday, 10:00 on the 10th of every month, or 8:00 on every Valentine's day. Setting the related application includes determining at least one application for executing the scheduled task, for example, a scheduled task of shopping can be executed by a shopping application.

The setting interface 114 defines an option 115 for setting the identification. The option 115 provides a “Yes” option and a “No” option. Setting the identification includes activating an identification function by selecting the “Yes” option on the option 115. When the identification function is activated, a user identification is required before the scheduled task is executed. When the identification function is not activated, the scheduled task can be executed without any identification. Setting a prompt includes setting a time interval between a current time and an execution time of the scheduled task.

Furthermore, when multiple scheduled tasks have a same execution time, the setting module 101 can predetermine a priority of the multiple scheduled tasks, and the multiple scheduled tasks can be executed according to the priority.

The setting module 101 is further used to predetermine at least one schedule operation in the application related to the scheduled task.

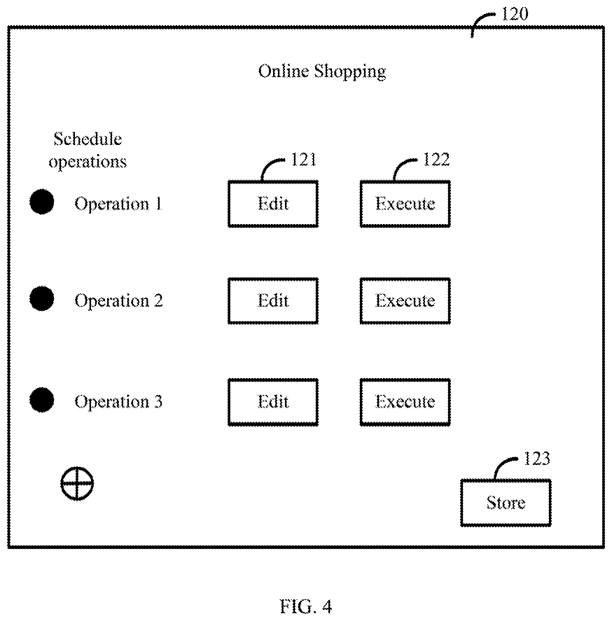

Referring to FIG. 4, in at least one embodiment, the setting module 101 predetermines the at least one schedule operation in response to the user operations in an application interface 120. In detail, when the scheduled task is edited, the application in relation to the scheduled task should be activated by the user, and the schedule operation is predetermined in the application interface 120.

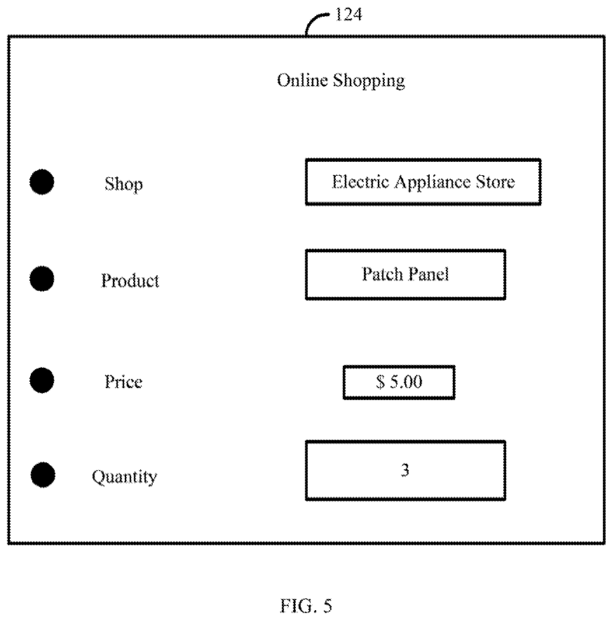

The user can predetermine multiple operations in the application, and activate an editing option 121 in the application interface 120 to predetermine each schedule operation. Referring to FIG. 5, when the editing option 121 is activated, the application interface 120 enters a schedule operation editing interface 124, each schedule operation is predetermined by inputting settings in the schedule operation editing interface 124.

For example, the settings of a schedule operation about shopping at least include a name, a price, and a quantity of a product to be purchased, and a name of a shop offering the product. The specific operations, performed by the shopping application in relation to the shopping task, include purchasing the preset quantity of the products in the preset shop at the preset price.

For example, the settings of a schedule operation about an account transfer at least include an account number of a payer, an amount of money to be transferred, an account number of a payee, and a notification mailbox. The specific operations, performed by the online banking application in relation to the account transfer task, include transferring the preset amount of money from the preset payer account to the preset payee account, and sending an e-mail to the preset notification mailbox for indicating by prompt that the amount is successfully transferred.

Furthermore, the application interface 120 defines an execution option 122 and a storage option 123. The execution option 122 is activated by the user to manually control the application to perform the corresponding schedule operations. When the schedule operation of the application is predetermined, the storage option 123 is activated to trigger the electronic device 1 to store the schedule operation of the application.

The determining module 102 is used to determine whether the scheduled task requires a user identification, when a current time arrives at the predetermined execution time corresponding to the scheduled task.

In at least one embodiment, when the current time arrives at the predetermined execution time corresponding to the scheduled task, the determining module 102 determines whether the user requires to be identified, according to the identification setting information related to the scheduled task in the schedule management application 100. When the identification function is activated, the determining module 102 determines that the scheduled task requires the user identification. When the identification function is not activated, the determining module 102 determines that the scheduled task does not require the user identification.

The identification module 103 is used to verify an identity of the user when the determining module 102 determines that the scheduled task requires the user identification.

In at least one embodiment, the identification module 103 can output a prompt to prompt the user that the scheduled task requires the user identification. The prompt can be a text prompt or a voice prompt.

When the identification device 40 is a fingerprint identification device, the identification module 103 prompts the user to input at least one fingerprint, the identification device 40 acquires the user fingerprint when the user finger touches a fingerprint collector (not shown) of the electronic device 1. The identification module 103 compares the fingerprint acquired by the identification device 40 with a pre-stored user fingerprint. When the acquired fingerprint matches the pre-stored user fingerprint, the identification module 103 determines that the identity of the user is verified.

In other embodiments, when the identification device 40 is a face recognition device, the identification module 103 prompts the user to present his/her face to the identification device 40. The identification device 40 captures an image of the user face, and the identification module 103 compares the image of the user face captured by the identification device 40 with a pre-stored image of the user face. When the captured image of the user face matches the pre-stored image of the user face, the identification module 103 determines that the identity of user is verified.

The activating module 104 is used to activate the application in relation to the scheduled task, when the determining module 102 determines that the scheduled task does not require the user identification or when the identity of the user is verified.

For example, when the current scheduled task is online shopping, the corresponding application in relation to the scheduled task can be an e-commerce application, and the activating module 104 can activate the e-commerce application. When the current scheduled task is an account transfer, the corresponding application can be the online banking application, and the activating module 104 can activate the online banking application.

The executing module 105 is used to control the application to perform the predetermined schedule operation.

In at least one embodiment, when the application in relation to the scheduled task is activated by the activating module 104, the schedule management application 100 automatically activates the storage option 123 to trigger the executing module 105, and the executing module 105 can control the application to perform the predetermined schedule operation.

In at least one embodiment, the executing module 105 performs the corresponding schedule operation according to the input settings in each application in relation to the scheduled task.

For example, when the scheduled task is the online shopping, the executing module 105 controls the e-commerce application to search for the predetermined shop, search for the predetermined product in the predetermined shop, and compare the price of the product with the predetermined price. If the price is equal to or less than the predetermined price, the executing module 105 controls the e-commerce application to purchase the predetermined quantity of products, and pay the predetermined price to the shop.

Furthermore, when multiple schedule operations are preset in the application in relation to the scheduled task, the execution module 105 can control the application to execute the multiple schedule operations in sequence. When the scheduled task is associated with multiple applications, the activating module 104 can activate the multiple applications in sequence.

The prompt module 106 is used to prompt the user that the scheduled task is completed when the at least one predetermined schedule operation has been performed.

In at least one embodiment, when the at least one predetermined schedule operation has been performed, the prompt module 106 displays a prompt interface on the display device 30, and controls the electronic device 1 to output a voice message to prompt the user that the scheduled task is completed.

In at least one embodiment, the prompt interface can be a pop-up window, which is used for displaying prompt information, such as a successful purchase or a successful transfer.

The voice message can be a preset ringtone, preset vibration, or a preset voice. For example, when the online shopping scheduled task is completed, the prompt module 106 controls the electronic device 1 to output a voice message with content of “Purchase of XX (the name of the product) is completed”.

In at least one embodiment, the prompt module 106 can further prompt the user that the scheduled task is failed. In detail, if the schedule task is not completed in a predetermined time interval, the prompt module 106 displays a prompt interface on the display device 30, and controls the electronic device 1 to output a voice message to prompt the user that the scheduled task is failed. The predetermined time interval can be ten minutes.

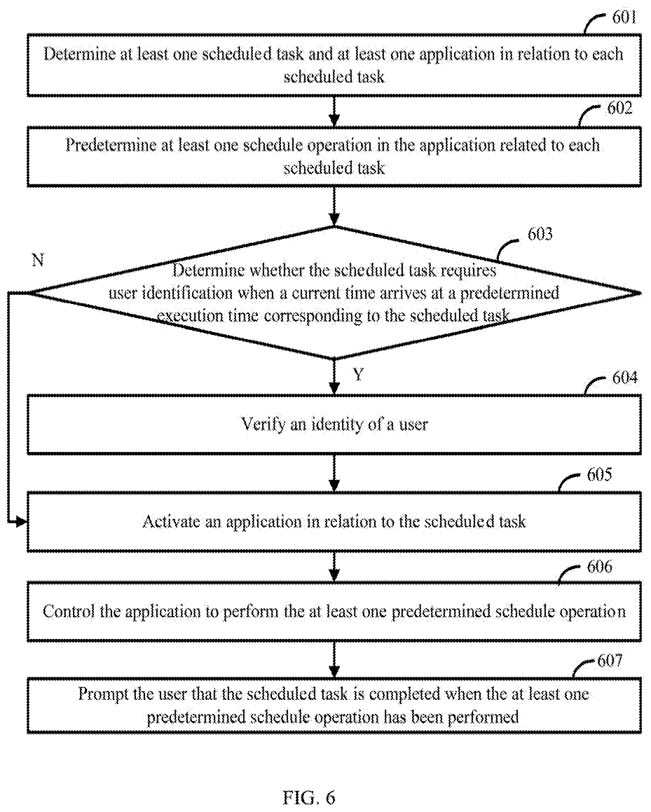

FIG. 6 illustrates a flowchart of an embodiment of a schedule processing method. The method is provided by way of example, as there are a variety of ways to carry out the method. The method described below can be carried out using the configurations illustrated in FIG. 1, for example, and various elements of these figures are referenced in explaining the example method. Each block shown in FIG. 6 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 601.

At block 601, a setting module 101 determines at least one scheduled task and at least one application in relation to each scheduled task.

At block 602, the setting module 101 further predetermines at least one schedule operation in the application related to each scheduled task.

At block 603, the determining module 102 determines whether the scheduled task requires user identification, when the current time arrives at the predetermined execution time corresponding to the scheduled task.

At block 604, the identification module 103 verifies the identity of the user when the determining module 102 determines that the scheduled task requires the user identification.

At block 605, the activating module 104 activates the application in relation to the scheduled task, when the determining module 102 determines that the scheduled task does not require the user identification or when the identity of the user is verified.

At block 606, the executing module 105 controls the application to perform the predetermined schedule operation.

At block 607, the prompt module 106 prompts the user that the scheduled task is completed.

In at least one embodiment, the prompt module 106 displays a prompt interface on the display device 30 when the scheduled task is completed, and control the electronic device 1 to output a voice message to prompt the user that the scheduled task is completed.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. An electronic device comprising:
at least one processor; and
a storage device coupled to the at least one processor and storing instructions for execution by the at least one processor to cause the at least one processor to:
determine at least one scheduled task and at least one application in relation to each scheduled task;
activate the application in relation to the scheduled task when a current time arrives at a predetermined execution time corresponding to the scheduled task;
control the application to perform at least one predetermined schedule operation; and
prompt the user that the schedule is completed when the at least one predetermined schedule operation has been performed.

2. The electronic device according to claim 1, further comprising:
a schedule management interface for setting the at least one scheduled task, wherein setting the scheduled task comprises setting an execution time of each scheduled task, setting at least one application in relation to the at least one scheduled task, setting an identification, and setting a prompt.

3. The electronic device according to claim 2, wherein the at least one processor is further caused to:
determine whether the schedule requires a user identification when the current time arrives at the predetermined execution time corresponding to the schedule;
verify an identity of the user when the scheduled task requires the user identification; and
activate the application in relation to the schedule when the scheduled task does not require the user identification or when the identity of the user is verified.

4. The electronic device according to claim 3, further comprising:
an identification device coupled to the at least one processor, wherein the identification device is a fingerprint recognition device or a face recognition device, and the identification device verifies the identity of the user according to at least one fingerprint or at least one face image.

5. The electronic device according to claim 1, wherein the at least one processor is further caused to:
predetermine the at least one schedule operation in the application related to the scheduled task.

6. The electronic device according to claim 1, wherein the at least one processor is further caused to:
display a prompt interface on a display device of the electronic device when the at least one predetermined schedule operation has been performed, and control the electronic device to output a voice message to prompt the user that the scheduled task is completed.

7. A schedule processing method applicable in an electronic device comprising:
determining at least one scheduled task and at least one application in relation to each scheduled task;
activating the application in relation to the scheduled task when a current time arrives at a predetermined execution time corresponding to the scheduled task;
controlling the application to perform at least one predetermined schedule operation; and
prompting the user that the scheduled task is completed when the at least one predetermined schedule operation has been performed.

8. The method according to claim 7, wherein the electronic device provides a schedule management interface for setting the scheduled task, and setting the scheduled task comprises setting an execution time of each scheduled task, setting at least one application in relation to the at least one scheduled task, setting an identification, and setting a prompt.

9. The method according to claim 8, further comprising:
determining whether the scheduled task requires a user identification when the current time arrives at the predetermined execution time corresponding to the scheduled task;
verifying an identity of the user when the scheduled task requires the user identification; and
activating the application in relation to the scheduled task when the scheduled task does not require the user identification or when the identity of the user is verified.

10. The method according to claim 9, wherein the electronic device comprises an identification device, the identification device is a fingerprint recognition device or a face recognition device, and the identification device verifies the identity of the user according to at least one fingerprint or at least one face image.

11. The method according to claim 7, further comprising:
predetermining the at least one schedule operation in the application related to the scheduled task.

12. The method according to claim 7, wherein the step of prompting the user that the scheduled task is completed comprises:
displaying a prompt interface on a display device of the electronic device when the at least one predetermined schedule operation has been performed; and
controlling the electronic device to output a voice message to prompt the user that the scheduled task is completed.

13. A non-transitory storage medium having instructions stored thereon, when the instructions are executed by a processor of an electronic device, the processor is configured to perform a schedule processing method, wherein the method comprises:
determining at least one scheduled task and at least one application in relation to each scheduled task;
activating the application in relation to the scheduled task when a current time arrives at a predetermined execution time corresponding to the scheduled task;
controlling the application to perform at least one predetermined schedule operation; and
prompting the user that the scheduled task is completed when the at least one predetermined schedule operation has been performed.

14. The non-transitory storage medium according to claim 13, wherein the electronic device provides a schedule management interface for setting the scheduled task, and setting the scheduled task comprises setting an execution time of each scheduled task, setting at least one application in relation to the at least one scheduled task, setting an identification, and setting a prompt.

15. The non-transitory storage medium according to claim 14, further comprising:
determining whether the scheduled task requires a user identification when the current time arrives at the predetermined execution time corresponding to the scheduled task;
verifying an identity of the user when the scheduled task requires the user identification; and
activating the application in relation to the scheduled task when the scheduled task does not require the user identification or when the identity of the user is verified.

16. The non-transitory storage medium according to claim 15, wherein the electronic device comprises an identification device, the identification device is a fingerprint recognition device or a face recognition device, and the identification device verifies the identity of the user according to at least one fingerprint or at least one face image.

17. The non-transitory storage medium according to claim 13, further comprising:
predetermining the at least one schedule operation in the application related to the scheduled task.

18. The non-transitory storage medium according to claim 13, wherein the step of prompting the user that the scheduled task is completed comprises:
displaying a prompt interface on a display device of the electronic device when the at least one predetermined schedule operation has been performed; and
controlling the electronic device to output a voice message to prompt the user that the scheduled task is completed.
